(19) United States
(12) Patent Application Publication
(10) Pub. No.: US 2005/0204088 A1
(43) Pub. Date: Sep. 15, 2005

(54) Data acquisition methods

(75) Inventors: Kuan-Jui Ho, Taipei (TW); Stephen Chen, Taipei (TW); Ruei-Ling Lin, Taipei (TW); Chien-Ping Chung, XinZhuang City (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: VIA Technologies Inc.

(21) Appl. No.: 11/051,449

(22) Filed: Feb. 4, 2005

(30) Foreign Application Priority Data
Feb. 12, 2004 (TW) 93103288

(51) Int. Cl. G06F 13/00; G06F 12/00

(52) U.S. Cl. 710/308; 710/311; 711/146

(57) ABSTRACT

Data acquisition methods and systems in support of non-snoop transactions. In the data acquisition method, the cache memory is partially written back and invalidate, such that a portion of the data in the cache memory is written back to the DMA buffer. The endpoint device is directed to use a non-snoop transaction to read the data stored in the DMA buffer. The data stored in the DMA buffer is acquired directly without snooping the processor when receiving a non-snoop read transaction.

### BACKGROUND

The invention relates to data acquisition methods, and more particularly, to data acquisition methods supporting non-snoop transactions.

Personal computer systems typically include one or more processors and a microprocessor cache memory system for each processor. A cache memory is a small amount of very fast, expensive, zero-wait state memory storing frequently used code and data. The cache memory is the interface between a respective processor and a system bus and bridges the gap between fast processor cycle times and relatively slow memory access times.

Due to speed and bandwidth requirements in advanced electronic devices, the non-snoop transaction for peripheral component interface (PCI) master device is disclosed for reading or writing direct memory access (DMA) buffers in system memory (DRAM) without snooping cache memory via a north bridge. There are two advantages in computer systems utilizing non-snoop transactions, namely system bus can be used by another master and access latency can be predicted.

For example, for a non-snoop transaction, the PCI master can always read data from system memory during a read procedure, and thus, the access latency can be predicted by read-DRAM-latency. Conversely, for snoop transaction, the access latency cannot be expected because the access latency can be read-DRAM-latency or snoop-CPU-latency.

Further, for non-snoop transactions, the PCI master can always write data into system memory by post-write during a write procedure. Conversely, for snoop transactions, if snooped result is hit dirty, the PCI master write data is merged with system memory after waiting for the data in cache memory to be written back to the DRAM by the CPU. If the snooped result is not hit dirty, the PCI master data is written to the system memory by a post-write when the snoop is complete.

Many conventional methods utilize non-snoop transaction to enable the north bridge to read or write DMA buffers in system memory without snooping the processor. The conventional methods, however, have either poor performance or cache coherency issues.

### SUMMARY

Embodiments of a data acquisition method for a data system comprising a processor, a host bridge, an endpoint device of a PCI-Express link, DMA controller and a cache storing data, in which the cache memory is partially written back and invalidated, such that a portion of data in the cache memory is written back to the DMA buffer. The endpoint device is directed to use a non-snoop transaction to read the data stored in the DMA buffer. The host bridge acquires the data stored in the DMA buffer directly without snooping the processor when receiving a non-snoop read transaction.

Also disclosed are embodiments of a data acquisition system, in which a cache memory stores data and a processor is coupled to the cache memory. An endpoint device is coupled to a peripheral component interface express (PCI-Express) link. A main memory comprises at least one direct memory access (DMA) buffer. A host bridge is coupled to the endpoint device, enabling the processor to write a portion of data in the cache memory back to the DMA buffer in the main memory, invalidating the portion of data and directing the endpoint device to use a non-snoop transaction to read the data stored in the DMA buffer. The host bridge acquires the data stored in the DMA buffer directly without snooping the processor when receiving a non-snoop read transaction

Also disclosed are embodiments of a data acquisition system, in which an endpoint device is coupled to a peripheral component interface express (PCI-Express) link and a host bridge coupled to the endpoint device. A main memory comprises at least one direct memory access (DMA) buffer and a cache memory stores data. Aprocessor is programmed to write a portion of data in the cache memory back to the DMA buffer in the main memory, invalidate the portion of data and direct the endpoint device to use a non-snoop transaction to read the data stored in the DMA buffer. The host bridge acquires the data stored in the DMA buffer directly without snooping the processor when receiving a non-snoop read transaction.

### DESCRIPTION OF THE DRAWINGS

The invention can be more fully understood by the subsequent detailed description and examples with reference made to the accompanying drawings, wherein:

FIG. 1 shows an exemplary embodiment of a data acquisition system; and

FIG. 2 is a flowchart illustrating an embodiment of a data acquisition method.

### DETAILED DESCRIPTION

When a processor generates a read request and the requested data resides in its cache memory, then a cache read hit has occurred, and the processor can obtain the data from the cache memory without having to access the main memory. If the data is not in the cache memory, then a cache read miss occurs, and the memory request is forwarded to the system and the data is retrieved from the main memory, as would normally be done if the cache system did not exist. On a cache miss, the data that is retrieved from main memory is provided to the processor and is also written into the cache memory due to the statistical likelihood that this data will be requested again by the processor. Likewise, if a processor generates a write request, the write data can be written to the cache memory without having to access main memory over the system bus (in a write-back cache). This increases processor efficiency and reduces host bus utilization, allowing more bandwidth for other processors and bus masters.

An efficient cache system yields a high “hit rate,” which is the percentage of cache hits that occur during all memory accesses. When a cache system has a high hit rate, the majority of memory accesses are serviced with zero wait states. Therefore, a processor operating out of its local cache memory has a much lower “bus utilization.” This reduces system bus bandwidth used by the processor, making more bandwidth available for other bus masters. In addition, a processor can operate out of its local cache memory when it does not have control of the system bus, thereby increasing efficiency of the computer system.

Two principal types of cache systems are referred to as write-through cache systems and write-back cache systems. In write-through systems, write data from the processor is written into the cache and is also immediately written into main memory. This guarantees that the copy of data in the cache memory is coherent or consistent with the data in main memory. A drawback of write-through cache systems, however, is that host bus utilization is required for each processor write.

In a write-back cache system, processor write data is only written into the cache memory, and the write data is only written back to main memory when another device requests the data or it is cast out and replaced by a request for new data. When processor write data is written only into the cache system, the data held in the corresponding location in main memory is referred as stale or invalid data. The cache location is said to hold modified data. In write-back cache systems, the cache controller is required to watch or “snoop” the system bus during cycles by other bus masters, such as processors, as described below.

Cache management is generally performed by a device referred to as a cache controller. A principal cache management policy is the preservation of cache coherency. Cache coherency refers to the requirement that any bus device requesting data receives the most recent version of the data. The owner of a location's data is generally defined as the respective location having the most recent version of the data residing in the respective memory location. The data owner can be either an unmodified location in main memory, or a modified location in a write-back cache.

In computer systems where independent bus masters can access main memory, there is a possibility that a bus master, such as another processor, or a direct memory access controller, network or disk interface card, or video graphics card, might alter the contents of a main memory location that is duplicated in the cache memory. When this occurs, the cache memory is said to hold “stale” or invalid data. Problems would result if the processor inadvertently obtained this invalid data. In order to maintain cache coherency, therefore, it is necessary for the cache controller to monitor the system bus when the processor does not control the bus to see if another bus master accesses main memory. This method of monitoring the bus is referred to in the art as “snooping.”

The cache controller must also monitor the system bus during main memory reads by a bus master in a write-back cache design because of the possibility that a previous processor write may have altered a copy of data in the cache memory that has not been updated in main memory. This is referred to as read snooping. On a read snoop hit where the cache memory contains data not yet updated in main memory, the cache controller generally provides the respective data to main memory and to the requesting bus master.

The cache controller must also monitor the system bus during memory writes because the bus master may write to or alter a memory location that resides in its cache memory. This is referred to as write snooping. On a write snoop hit, the cache entry is either marked invalid in the cache controller, signifying that this entry is no longer correct, or the cache memory is updated along with the main memory.

Therefore, when a bus master reads or writes to main memory in a write-back cache design, or writes to main memory in a write-through cache design, the cache controller must latch the system address and see if the main memory location being accessed also resides in the cache memory. If a copy of the data from this location does reside in the cache memory, then the cache controller takes the appropriate action depending upon whether a read or write snoop hit has occurred. This prevents stale data from being stored in main memory and the cache memory, thereby preserving cache coherency.

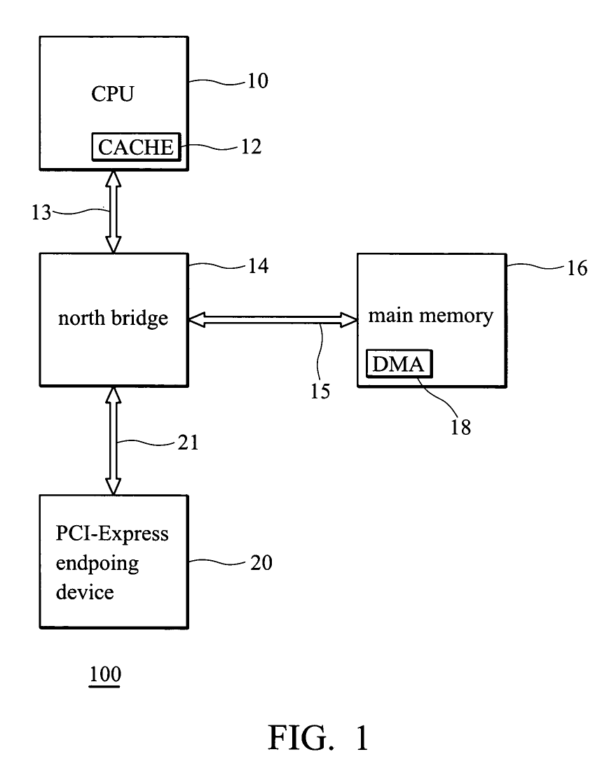

FIG. 1 is an exemplary embodiment of a data acquisition system. The data acquisition system 100 comprises aprocessor 10, a cache memory 12, a north bridge 14, a direct memory access (DMA) buffer 18 and an endpoint device 20 of a peripheral component interface express (PCI-Express) link.

The endpoint device 20 can be a bus master,.but it is to be understood that the invention is not limited thereto. The endpoint device can also be another processor, a DMA controller, a network interface card, a disk interface card, a video graphics card and the like. The processor 10 is coupled to the north bridge 14 through the system bus 13 and the north bridge 14 is coupled to the main memory comprising the DMA buffer 18 through the memory bus 15. The north bridge 14 is coupled to the endpoint device 20 through a PCI-Express link 21. A portion of main memory 16 is allocated to serve as the DMA buffer 18 for non-snoop transaction, and the DMA buffer is set to be written back by cache memory.

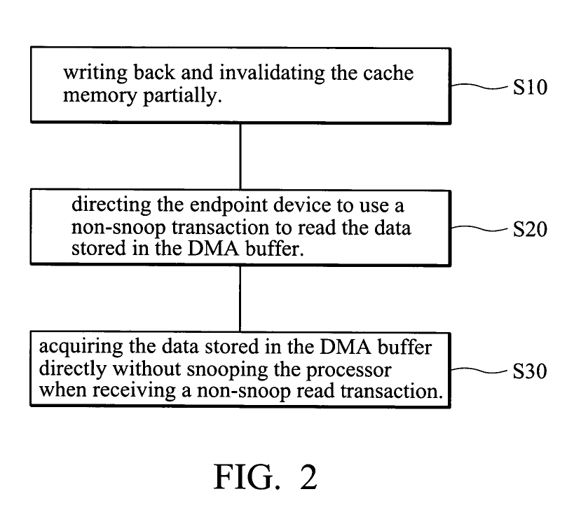

FIG. 2 is a flowchart illustrating an embodiment of a data acquisition method.

In step S10, the cache memory 12 is partially written back and invalidated when software or a driver attempts to access the DMA buffer 18 by a non-snoop read transaction.

In a conventional write back system, the processor 10 is required to execute a command “cache write back and invalidate (WBINV)” to move all data in the cache memory 12 and flush the entire cache memory 12, in order to update all modified data in the cache memory 12 to main memory 16.

Even if the software (or the driver) requires access to only the DMA buffer 18, however, all the entire data stored in the cache memory 16 including the DMA buffer is updated to main memory and flushed by the command “WBINV” executed by the processor 10, causing real time performance to suffer. In the invention, the cache memory 12 is partially written back and invalidated (partially flushed) to update data related to the DMA buffer 18 therein to the DMA buffer 18, if the software (or the driver) requires access to only the DMA buffer 18.

The invention provides two exemplary implementations of step S10, but it is to be understood that the invention is not limited thereto.

First embodiment

In the first embodiment, the step S10 is implemented by the processor 10. A new command “partial cache write back and invalidate (PWBINV)” is added to the processor 10, to write a portion of data in the cache memory back to the DMA buffer 18 and invalidate the portion data according to the information of two addresses. For example, the information of one of the two addresses can be a start address and the other can be an end address or length information.

Thus, when the software (or the driver) requires access to the DMA buffer 18 by a non-snoop read.transaction, the processor 10 is programmed by the command PWBINV to update data related to the DMA buffer in the cache memory to the DMA buffer 18 rather than updating all modified data in the cache memory 12 to main memory 16 according to information of two addresses. Thus, cache coherency of the data acquisition system is maintained and degradation of real time performance is prevented.

Next, in step S20, the endpoint device 20 is directed by the software (or the driver) to read the DMA buffer 18 using non-snoop transaction. In step S30, the north bridge 14 acquires the data stored in the DMA buffer 18 without snooping the processor 10 when receiving a non-snoop read request from the endpoint device 20. The north bridge 14 then conveys the acquired data from DMA buffer to the endpoint device 20 through the PCI-Express link 21.

Second embodiment

In the second embodiment, step S10 is implemented by north bridge 14. In north bridge 14, a first register and a second register (not shown) are used to store a start address and an end address for partially writing back and invalidating the cache memory respectively. A third register (not shown) is used to set operation state for partially writing back and invalidating the cache memory. If the third register is set to “1”, the north bridge 14 enables the processor 10 to write the modified data in the range between the start address and the end address in the cache memory back to the DMA buffer 18 and then invalidate the modified data within the range in the cache memory.

Therefore, when the software (or the driver) requires access to the DMA buffer 18 by a non-snoop read transaction, a start address and an end address are stored to the first and second registers of the north bridge 14 respectively and the operating state in the third register is set to “1” by an enable signal. Only the modified data within the range between the start address and the end address in the cache memory is updated to the DMA buffer 18 rather than modifying all the data in the cache memory 12 to main memory 16. Thus, not only cache coherency of the data acquisition system is maintained but also degradation of real time performance is prevented. The operating state in the third register is set to “0” after the modified data within the range between the start address and the end address in the cache memory is updated to the DMA buffer 18.

Next, in step S20, the endpoint device 20 is directed by the software (or the driver) to read the DMA buffer 18 using non-snoop transaction. In step S30, the north bridge 14 acquires the data stored in the DMA buffer 18 without snooping the processor 10 when receiving a non-snoop read request from the endpoint device 20. The north bridge 14 then conveys the acquireddata from DMA buffer to the endpoint device 20 through the PCI-Express link 21.

In the methods of the invention, not only cache coherency of the data acquisition system is maintained but also degradation in real time performance is prevented because only a portion of data in the cache memory is updated to DMA buffer 18.

Third embodiment

As shown in FIG. 1, the data acquisition system 100 comprises a processor 10, a cache memory 12, a north bridge 14, a direct memory access (DMA) buffer 18 and an endpoint device 20 coupled to a peripheral component interface express (PCI-Express) link 21.

In this embodiment, the endpoint device 10 can be a bus master, but it is to be understood that the invention is not limited thereto. The endpoint device 20 can also be another processor, a DMA controller, a network interface card, a disk interface card, a video graphics card and the like. A portion of main memory 16 is allocated to serve as the DMA buffer 18 for non-snoop transactions, and the DMA buffer 18 is set to be written back by cache memory 12.

The processor 10 is coupled to the north bridge 14 through the system bus 13, and the cache memory 12 can be disposed in the processor 10 or out of the processor 10. The processor 10 is designed to be programmed by a PWBINV command to write a portion of data in the cache memory back to the DMA buffer 18 and invalidate the portion of data according to the information of two addresses. For example, the information of one of the two addresses can be a start address and the other can be an end address or length information.

Therefore, when the software (or the driver) requires access to the DMA buffer 18 by a non-snoop read transaction, a PWBINV command is conveyed to the processor 10, such that the processor 10 is programmed by the command PWBINV to write a portion of data in the cache memory back to the DMA buffer and then invalidate the portion of data according to the information of the two addresses. Namely, the processor 10 only updates data related to the DMA buffer 18 in the cache memory 12 to the DMA buffer 18 rather than updating all modified data in the cache memory 12 to the main mem6ry 16. Thus, not only cache coherency of the data acquisition system is maintained but also degradation in real time performance is prevented.

The north bridge 14 is coupled to the main memory comprising the DMA buffer 18 through the memory bus 15 and the north bridge 14 is coupled to the endpoint device 20 through the PCI-Express link 21. The endpoint device 20 is directed by the software (or the driver) to read the DMA buffer 18 using a non-snoop transaction after the data related to the DMA buffer 18 in the cache memory 12 is updated to the DMA buffer 18. The north bridge 14 acquires the data stored in the DMA buffer 18 without snooping the processor 10 when receiving a non-snoop read request from the endpoint device 20. The north bridge 14 then conveys the acquired data from DMA buffer to the endpoint device 20 through the PCI-Express link 21.

Fourth embodiment

As shown in FIG. 1, the data acquisition system 100 comprises a processor 10, a cache memory 12, a north bridge 14, a direct memory access (DMA) buffer 18 and an endpoint device 20 coupled to a peripheral component interface express (PCI-Express) link 21.

In this embodiment, the endpoint device 10 can be a bus master, but it is to be understood that the invention is not limited thereto. The endpoint device 20 can also be another processor, a DMA controller, a network interface card, a disk interface card, a video graphics card and the like. A portion of main memory 16 is allocated to serve as the DMA buffer 18 for non-snoop transactions, and the DMA buffer 18 is set to be written back by cache memory 12.

The processor 10 is coupled to the north bridge 14 through the system bus 13, and the cache memory 12 can be disposed in the processor 10 or not.

The north bridge 14 is coupled to the main memory comprising the DMA buffer 18 through the memory bus 15, and the north bridge 14 is coupled to the endpoint device 20 through the PCI-Express link 21. The north bridge 14 is designed to enable the processor 10 to write the modified data within the range between a start address and an end address in the cache memory to the DMA buffer 18 and then invalidate the data within the range in the cache memory, according to the start address, the end address and an enable signal.

For example, in the north bridge 14, a first register and a second register (not shown) are used to store a start address and an end address for partially writing back and invalidating the cache memory respectively. A third register (not shown) is used to set operating state for partially writing back and invalidating the cache memory. If the third register is set to “1” , the north bridge 14 enables the processor 10 to write the modified data in the range between the start address and the end address in the cache memory back to the DMA buffer 18 and then invalidate the modified data within the range in the cache memory.

Thus, when the software (or the driver) requires access to the DMA buffer 18 by a non-snoop read transaction, a start address and an end address are stored to the first and second registers of the north bridge 14 respectively and the operating state in the third register is set to “1” by an enable signal. Only the modified data within the range between the start address and the end address in the cache memory is updated to the DMA buffer 18 rather than modifying the all data in the cache memory 12 to main memory 16. Thus, not only cache coherency of the data acquisition system is maintained but also degradation in real time performance is prevented. The north bridge 14 sets the operating state in the third register to “0” after the modified data within the range between the start address and the end address in the cache memory is updated to the DMA buffer 18.

The endpoint device 20 is then directed by the software (or the driver) to read the DMA buffer 18 using a non-snoop transaction. The north bridge 14 acquires the data stored in the DMA buffer 18 without snooping the processor 10 when receiving a non-snoop read request from the endpoint device 20. The north bridge 14 then conveys the acquired data from DMA buffer to the endpoint device 20 through the PCI-Express link 21.

In the data acquisition system of the invention, not only cache coherency of the data acquisition system is maintained but also degradation of real time performance is prevented because only a portion of data in the cache memory is updated to DMA buffer 18. It should be noted that, when software (or driver) attempts to access the main memory 16 normally, the processor 10 also can be programmed by a conventional WBINV command to write the all modified data in entire cache memory to the main memory, thereby maintaining cache coherency of the data acquisition system.

While the invention has been described by way of example and in terms of preferred embodiment, it is to be understood that the invention is not limited thereto. To the contrary, it is intended to cover various modifications and similar arrangements (as would be apparent to those skilled in the art) . Therefore, the scope of the appended claims should be accorded the broadest interpretation so as to encompass all such modifications and similar arrangements.

1. A data acquisition system, comprising:
a cache memory, storing data;
a processor, coupled to the cache memory;
an endpoint device coupled to a peripheral component interface express (PCI-Express) link;
a main memory, comprising at least one direct.memory access (DMA) buffer; and
a host bridge, coupled to the endpoint device, enabling the processor to write a portion of data in the cache memory back to the DMA buffer in the main memory, invalidating the portion of data and directing the endpoint device to use a non-snoop transaction to read the data stored in the DMA buffer, and the host bridge acquires the data stored in the DMA buffer directly without snooping the processor when receiving a non-snoop read transaction.

2. The data acquisition system as claimed in claim 1, wherein the host bridge enables the processor to write the portion of data in the cache memory back to the DMA buffer in the main memory and invalidating the portion of data according to a command comprising a start address and an end address.

3. The data acquisition system as claimed in claim 2, wherein the main memory is coupled to the host bridge through a memory bus.

4. The data acquisition system as claimed in claim 2, wherein the processor and the cache memory are coupled to the host bridge through a system bus.

5. The data acquisition system as claimed in claim 2, wherein the endpoint device is coupled to the host bridge through the PCI-Express link.

6. The data acquisition system as claimed in claim 2, wherein the endpoint device is a DMA controller.

7. The data acquisition system as claimed in claim 2, wherein the endpoint device is a video graphics card.

8. The data acquisition system as claimed in claim 2, wherein the endpoint device is a disk interface card.

9. The data acquisition system as claimed in claim 2, wherein the endpoint device is a network interface.

10. A data acquisition system, comprising:
an endpoint device coupled to a peripheral component interface express (PCI-Express) link;
a host bridge coupled to the endpoint device;
a main memory, comprising at least one direct memory access (DMA) buffer;
a cache memory, storing data; and
a processor, programmed to write a portion of data in the cache memory back to the DMA buffer in the main memory, invalidate the portion of data and direct the endpoint device to use a non-snoop transaction to read the data stored in the DMA buffer, and the host bridge acquires the data stored in the DMA buffer directly without snooping the processor when receiving a non-snoop read transaction.

11. The data acquisition system as claimed in claim 10, wherein the processor writes the portion of data in the cache memory back to the DMA buffer in the mainmemory and invalidates the portion of data according to a command comprising a start address and an end address.

12. The data acquisition system as claimed in claim 10, wherein the main memory is coupled to the host bridge through a memory bus.

13. The data acquisition system as claimed in claim 10, wherein the processor and the cache memory are coupled to the host bridge through a system bus.

14. The data acquisition system as claimed in claim 10, wherein the endpoint device is coupled to the host bridge through the PCI-Express link.

15. A data acquisition method, used for a non-snoop transaction system comprising a processor, an endpoint device of a PCI-Express link, a DMA buffer and a cache storing data, the method comprising:
writing a portion of data in the cache memory back to the DMA buffer;
invalidating the portion of data in the cache memory; and
directing the endpoint device to use a non-snoop transaction to read the data stored in the DMA buffer, such that the host bridge acquires the data stored in the DMA buffer directly without snooping the processor when receiving a non-snoop read transaction.

16. The data acquisition method as claimed in claim 15, wherein the processor writes the portion of data in the cache memory back to the DMA buffer in the main memory and invalidates the portion of data according to a command comprising a start address and an end address.

17. The data acquisition method as claimed in claim 15, wherein the host bridge enables the processor to write the portion of data in the cache memory back to the DMA buffer in the main memory and invalidating the portion of data according to a command comprising a start address and an end address.

18. A data acquisition method, used for a non-snoop transaction system comprising a processor, an endpoint device of a PCI-Express link, a DMA buffer and a cache storing data, the method comprising:
writing back and invalidating the cache memory partially, such that a portion data in the cache memory is written back to the DMA buffer;
directing the endpoint device to use a non-snoop transaction to read the data stored in the DMA buffer; and
acquiring the data stored in the DMA buffer directly without snooping the processor when receiving a non-snoop read transaction.
